(19) United States
(12) Patent Application Publication
(10) Pub. No.: US 2002/0161705 A1
(43) Pub. Date: Oct. 31, 2002

(54) Debit cards and credit cards with weekly limits

(76) Inventors: Sajid Ali Mirza Khan, Ridgefield Park, NJ (US); Sheba Sarwat Khan, Ridgefield Park, NJ (US); Adil Ali Khan, Ridgefield Park, NJ (US)

Correspondence Address: SAJID ALI MIRZA KHAN, 2 UNION PLACE, RIDGEFIELD PARK, NJ, 07660, US

(21) Appl. No.: 09/846,556

(22) Filed: Apr. 30, 2001

(51) Int. Cl. G06F 17/60

(52) U.S. Cl. 705/41; 235/379

(57) ABSTRACT

A debit card or credit card with a weekly limit. The intention is to provide the weekly limit debit card to a loved one who can withdraw the intended amount of money in the intended period of time.

### BACKGROUND OF INVENTION

What is the advantage of a debit card with a weekly limit? Suppose I send my father three thousand dollars. I expect him to use the money over three months. He uses it all too fast, or it gets stolen. I send him a weekly limit debit card with which he may take out a hundred dollars a week. The money lasts as intended. A regular debit card could also be used to take out more money than intended.

### BRIEF SUMMARY OF INVENTION.

A debit or credit card with weekly limits will enable more people to let their loved ones use these cards. Especially those people working here and having poor relatives in their native countries.

### DETAILED DESCRIPTION OF INVENTION

Suppose I send my brother, who is living in India, a regular debit card and he uses it so fast and often that I run out of money here. Now if I send him a debit card with a limit he might still use up the money too fast. Therefor I need to send him a debit card with a weekly limit. This way he will use the amount intended over the intended time. The way it works is the card will be mailed to the beneficiary and after he receives it there it will be activated from here. The first pin code that he punches becomes the pin code for the card.

What we claim as our invention is a debit card with a weekly limit:

1. We have also invented a credit card with a weekly limit.

2. Currently we can have more than one debit card on a single account; each can withdraw all the money in the account. Let's say these arc ‘A’ class cards. We have invented a ‘B’ class debit card [and credit card] that has a weekly limit, and cannot withdraw all the money in the account only that much every week as allowed by the limit.

3. We also want to market debit cards that can be purchased like phone cards, and can be used all over the world.
